(19) United States
(12) Patent Application Publication
(10) Pub. No.: US 2012/0054752 A1
(43) Pub. Date: Mar. 1, 2012

(54) ELECTRONIC DEVICE HAVING OPERATION MODE DYNAMIC ADJUSTING MECHANISM AND METHOD OF THE SAME

(75) Inventor: Ssu-Po Chin, Taoyuan City (TW)

(73) Assignee: HTC CORPORATION, Taoyuan City (TW)

(21) Appl. No.: 13/117,219

(22) Filed: May 27, 2011

Related U.S. Application Data
(60) Provisional application No. 61/377,794, filed on Aug. 27, 2010.

(51) Int. Cl. G06F 9/46

(52) U.S. Cl. 718/100

(57) ABSTRACT

A method to dynamically adjust the operation mode of an electronic device is provided. The method comprises the steps as follows. Whether a foreground program executed by the electronic device is changed is detected. When the foreground program is changed, the changed foreground program is identified and a plurality of system operation state parameters are retrieved. A corresponding look-up table is retrieved from a plurality of look-up tables according to the system operation state parameters. At least one operation parameter is searched in the corresponding look-up table according to the system operation state parameters to adjust an operation mode of the electronic device. An electronic device having the operation mode dynamic adjustment mechanism is disclosed herein as well.

### RELATED APPLICATIONS

This application claims priority to U.S. Provisional Application Ser. No. 61/377,794, filed Aug. 27, 2010, which is herein incorporated by reference.

### BACKGROUND

1. Technical Field

The present disclosure relates to an electronic device and an operation method of the same. More particularly, the present disclosure relates to a method to dynamically adjust the operation mode of an electronic device and an electronic device having a mechanism to dynamically adjust its operation mode.

2. Description of Related Art

The electronic devices such as cell phones and computers bring convenience to our life. The communication and the information exchange becomes fast and easy. As the trend towards smaller size continues, the design of a more efficient and power-saving electronic devices is necessary.

Take the central processing unit (CPU) of the electronic device as an example. Most of the electronic device uses the total amount of data that is computed by the CPU at a specific time interval as a reference to determine when to raise or lower the operating frequency of the CPU. When the amount of data is large, the operating frequency of the CPU is raised. On the contrary, when the amount of data is small, the operating frequency of the CPU is lowered. However, when a foreground program that consumes lots of resource in a short time period is executed while the total loading of the CPU does not reach the threshold value, the CPU may not raise the operating frequency high enough to deal with such a kind of foreground program. In other situations, the operating frequency of the CPU may also raise too much when the foreground program only consumes a small amount of resource.

Accordingly, what is needed is an electronic device having a mechanism to dynamically adjust its operation mode. The present disclosure addresses such a need.

### SUMMARY

An aspect of the present disclosure is to provide a method to dynamically adjust the operation mode of an electronic device. The method comprises the steps as follows. Whether a foreground program executed by the electronic device is changed is detected. The foreground program is identified when the foreground program is changed and a plurality of system operation state parameters are retrieved. A corresponding look-up table is retrieved from a plurality of look-up tables according to the system operation state parameters. At least one operation parameter in the corresponding look-up table is retrieved according to the system operation state parameters to adjust an operation mode of the electronic device.

According to an embodiment of the present disclosure, the plurality of system operation state parameters comprise a foreground program identification parameter, where the step of retrieving the corresponding look-up table is performed according to the foreground program identification parameter. When there is no look-up table corresponding to the foreground program identification parameter, a default look-up table is retrieved from the plurality of look-up tables.

According to another embodiment of the present disclosure, the system operation state parameters comprise a system load, where the operation mode of the electronic device is adjusted according to the system load. The operation parameter comprises an operation clock rate, where the operation mode of the electronic device is adjusted by adjusting an operating frequency of the electronic device to the retrieved operation clock rate. The operating frequency is the operating frequency of a CPU of the electronic device. The corresponding look-up table comprises a plurality of loading threshold values, the step of retrieving the operation parameter in the corresponding look-up table according to the system operation state parameters to adjust the operation mode of the electronic device further comprises determining the relation of the system load and the loading threshold values to retrieve the operation parameter according to the relation.

According to yet another embodiment of the present disclosure, the method further comprises a step of detecting the change of at least one background program executed by the electronic device to retrieve the plurality of system operation state parameters according to the changed foreground program and the background program.

Another aspect of the present disclosure is to provide an electronic device having a mechanism to dynamically adjust its operation mode, wherein the electronic device comprises a detecting module, a storing module, a retrieving module and a processing module. The detecting module detects whether a foreground program executed by the electronic device is changed and to identify the foreground program when the foreground program is changed to further retrieve a plurality of system operation state parameters. The storing module stores a plurality of look-up tables. The retrieving module retrieves a corresponding look-up table from the plurality of look-up tables according to the system operation state parameters. The processing module retrieves at least one operation parameter in the corresponding look-up table according to the system operation state parameters to adjust the operation mode of the electronic device.

According to an embodiment of the present disclosure, the plurality of system operation state parameters comprise a foreground program identification parameter, where the retrieving module retrieves the corresponding look-up table according to the foreground program identification parameter. When there is no look-up table corresponding to the foreground program identification parameter, a default look-up table is retrieved from the plurality of look-up tables by the retrieving module.

According to another embodiment of the present disclosure, the system operation state parameters comprise a system load, where the operation mode of the electronic device is adjusted according to the system load. The operation parameter comprises an operation clock rate, where the operation mode of the electronic device is adjusted by adjusting an operating frequency of the electronic device to the retrieved operation clock rate. The operating frequency is the operating frequency of a CPU of the electronic device. The corresponding look-up table comprises a plurality of loading threshold values, the processing module further determines the relation of the system load and the loading threshold values to retrieve the operation parameter according to the relation.

According to yet another embodiment of the present disclosure, the detecting module further detects the change of at least one background program executed by the electronic device to retrieve the plurality of system operation state parameters according to the changed foreground program and the background program.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of the electronic device having a mechanism to dynamically adjust its operation mode in an embodiment of the present disclosure;

FIG. 2 is a flow chart of a method to dynamically adjust the operation mode of an electronic device; and

FIG. 3A and FIG. 3B are the diagrams of the look-up tables in an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

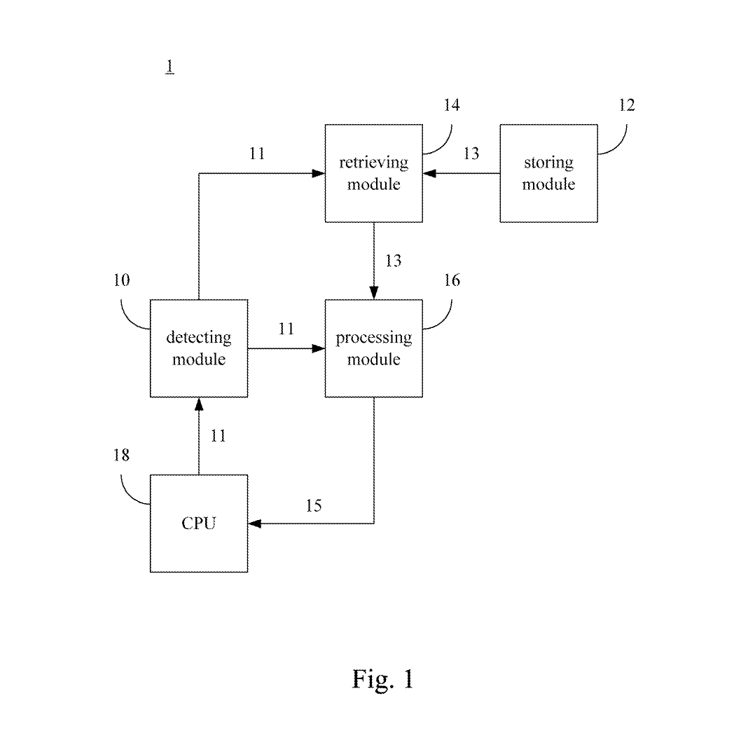

Please refer to FIG. 1. FIG. 1 is a block diagram of the electronic device 1 having a mechanism to dynamically adjust its operation mode in an embodiment of the present disclosure. The electronic device 1 can be handheld mobile device such as a mobile phone, a smart phone or a personal digital assistant. The electronic device 1 can also be a desktop or a notebook computer. The electronic device 1 comprises a detecting module 10, a storing module 12, a retrieving module 14 and a processing module 16.

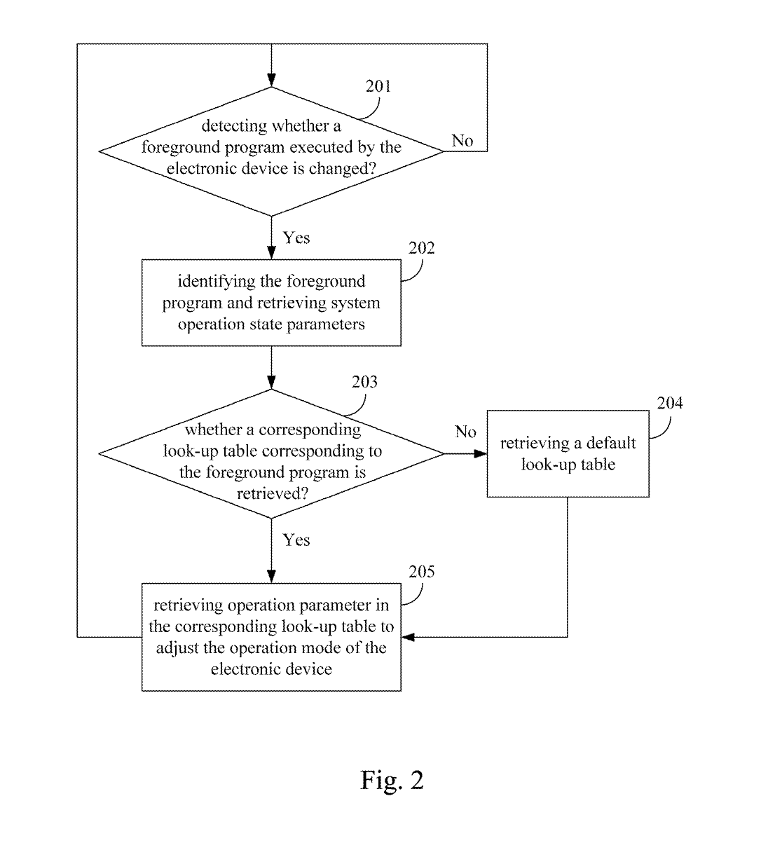

Please refer to FIG. 2 at the same time. FIG. 2 is a flow chart of a method to dynamically adjust the operation mode of an electronic device. The method can be adapted in the electronic device 1 depicted in FIG. 1. The method comprises the steps as follows. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 201, the detecting module 10 detects whether a foreground program (not shown) executed by the electronic device 1 is changed. Substantially, after the operation system of the electronic device 1 is activated, various foreground and background programs are executed according to the setting of the system and the operation of the user. In an embodiment, the detecting module 10 detects the foreground and the background programs (not shown) executed by the central processing unit (CPU, not shown) of the electronic device 1. Take the smart phone for example. The user is able to execute an audio playback program such that the audio playback program becomes the foreground program executed by the user. At the same time, the system of the smart phone may execute some background programs to monitor the operation condition of the system, e.g. the programs for monitoring the voltage and temperature of the system. In an embodiment, the detection mechanism executed by the detecting module 10 is also one of the background programs. In an embodiment, only one foreground program is executed at a time in the electronic device 1, while there can be one or more background programs executed simultaneously.

Hence, the detecting module 10 is able to detect whether the foreground program executed by the electronic device 1 is changed, e.g. every 200 ms or every 500 ms, which can be determined by the user. In an embodiment, the event that makes the detection mechanism detect the change is that when the user switches between different applications or that when some specific system behaviors happen, such as when the backlight module (not shown) of the electronic device 1 enters the power-saving mode automatically to lower its brightness since it is unused over a specific time period or when the backlight module turns to the operation mode from the power-saving mode to raise its brightness.

In step 202, when the foreground program changes, the detecting module 10 further identifies the foreground program and further retrieves a plurality of system operation state parameters 11. For example, the detecting module 10 detects the change of the foreground program when the user switches the applications from the audio playback program to a web browser or when the backlight module lowers its brightness since it is unused over a specific time period. The detecting module 10 can thus identify the web browser or the power-saving mode as the new foreground program. Further, the detecting module 10 retrieves the system operation state parameters 11 from the CPU 18 according to the current foreground and background programs.

In an embodiment, the system operation state parameters 11 comprise a foreground program identification parameter and a system load. The foreground program identification parameter is to identify which program or which system behavior makes the foreground program change. The system load shows the loading of the electronic device 1 when the foreground program changes. In an embodiment, the usage of the CPU 18 of the electronic device 1 is used as a reference of the system load. In other embodiments, other parameters may be used as the reference of the system load.

In step 203, the retrieving module 14 searches the storing module 12 that stores a plurality of look-up tables to determine whether a corresponding look-up table 13 corresponding to the foreground program can be retrieved. In an embodiment, the retrieving module 14 searches for the corresponding look-up table 13 according to the foreground program identification parameter. The various look-up tables stored in the storing module 12 correspond to different foreground programs. Consequently, the electronic device 1 can dynamically adjust its operation mode according to the look-up tables corresponding to the foreground programs that consumes different amount of resource.

In an embodiment, when there is no look-up table corresponding to the retrieved foreground program identification parameter, a default look-up table is retrieved from the look-up tables in step 204 such that the electronic devices can adjust its operation mode according to the default look-up table when there is no corresponding look-up table corresponding to the executed foreground program.

In step 205, the processing module 16 retrieves at least one operation parameter 15 in the corresponding look-up table 13 according to the system operation state parameters 11 to adjust the operation mode of the electronic device 1 according to the operation parameter 15. In an embodiment, the processing module 16 retrieves the operation parameter 15 according to the system load. The operation parameter 15 can be an operation clock rate such that the operating frequency of the CPU 18 can be adjusted to a proper operation clock rate. The efficiency of the CPU 18 can thus be optimized.

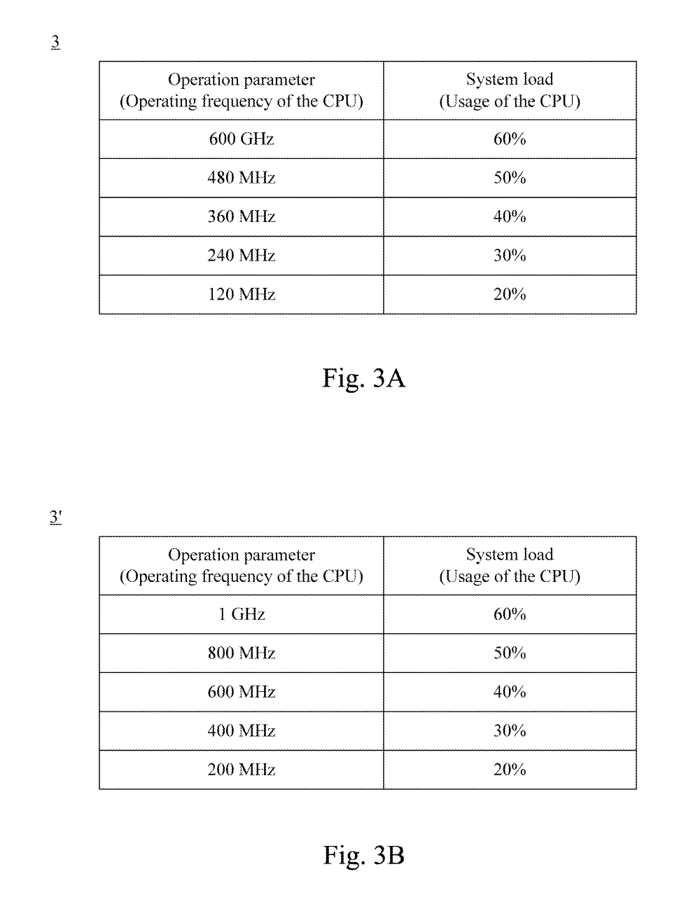

Please refer to FIG. 3A and FIG. 3B. FIG. 3A and FIG. 3B are the diagrams of the look-up tables 3 and 3′ respectively in an embodiment of the present disclosure. The look-up tables 3 and 3′ correspond to the audio playback program and the web browser respectively. Each of the look-up tables 3 and 3′ comprises a plurality of loading threshold values, such as the numbers 20%, 30%, 40%, 50% and 60% depicted in FIG. 3A and FIG. 3B. Each of these loading threshold values corresponds to an operation clock rate. The processing module 16 further determines the relation of the system load and these loading threshold values to retrieve the operation parameter according to the relation and further adjusts the operating frequency of the CPU 18.

For example, when the original foreground program is the audio playback program, the look-up table 3 is used to adjust the operation mode (i.e. the operating frequency in the present embodiment) of the CPU 18. Suppose that the operating frequency of the electronic device 1 is 240 MHz at an initial state of the execution of the audio playback program. If the system load decreases from the initial condition 25% to 15%, where 15% is a number between the threshold values 0% and 20%, the processing module 16 will lower the operating frequency to the operation clock rate of 120 MHz according to the look-up table 3.

After the user switches the applications from the audio playback program to the web browser, the flow depicted in FIG. 2 is activated. The processing module 16 switches the look-up table from the table 3 to the table 3′. If the web browser consumes lots of resource and raises the system load to 48%, where 48% is a number between the threshold values 40% and 50%, the processing module 16 will raise the operating frequency to the operation clock rate of 800 MHz according to the look-up table 3′ to adjust the operation mode of the electronic device 1 in accordance to different amount of resource consumed by the different foreground programs.

It's noticed that in other embodiments, the look-up table may comprise other types of parameter threshold such that the processing module can adjust other types of operation parameters of the electronic devices besides the system load and operating frequency, such as voltage or heat-dissipating efficiency according to the thresholds of voltage or heat-dissipating efficiency. Further, the arrangement of the modules depicted in FIG. 1 can be different in other embodiments, depending on the practical situations. For example, the processing module 16 can substantially be a part of the CPU 18.

The electronic device of the present disclosure is able to detect the foreground program in execution and the operation condition of the electronic device and further retrieve the corresponding look-up table to dynamically adjust the operation mode of the electronic device. Consequently, the electronic device with high efficiency and power-saving mechanism can be realized in the present disclosure.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method to dynamically adjust the operation mode of an electronic device comprising the steps of:
detecting whether a foreground program executed by the electronic device is changed;
identifying the foreground program when the foreground program is changed and retrieving a plurality of system operation state parameters;
retrieving a corresponding look-up table from a plurality of look-up tables according to the system operation state parameters;
retrieving at least one operation parameter in the corresponding look-up table according to the system operation state parameters to adjust an operation mode of the electronic device.

2. The method of claim 1, wherein the plurality of system operation state parameters comprise a foreground program identification parameter, where the step of retrieving the corresponding look-up table is performed according to the foreground program identification parameter.

3. The method of claim 2, wherein when there is no look-up table corresponding to the foreground program identification parameter, a default look-up table is retrieved from the plurality of look-up tables.

4. The method of claim 1, wherein the system operation state parameters comprise a system load, where the operation mode of the electronic device is adjusted according to the system load.

5. The method of claim 4, wherein the operation parameter comprises an operation clock rate, where the operation mode of the electronic device is adjusted by adjusting an operating frequency of the electronic device to the retrieved operation clock rate.

6. The method of claim 5, wherein the operating frequency is the operating frequency of a CPU of the electronic device.

7. The method of claim 5, wherein the corresponding look-up table comprises a plurality of loading threshold values, the step of retrieving the operation parameter in the corresponding look-up table according to the system operation state parameters to adjust the operation mode of the electronic device further comprises determining the relation of the system load and the loading threshold values to retrieve the operation parameter according to the relation.

8. The method of claim 1, further comprising a step of detecting the change of at least one background program executed by the electronic device to retrieve the plurality of system operation state parameters according to the changed foreground program and the background program.

9. An electronic device having a mechanism to dynamically adjust its operation mode, wherein the electronic device comprises:
a detecting module to detect whether a foreground program executed by the electronic device is changed and to identify the foreground program when the foreground program is changed to further retrieve a plurality of system operation state parameters;
a storing module to store a plurality of look-up tables;
a retrieving module to retrieve a corresponding look-up table from the plurality of look-up tables according to the system operation state parameters; and
a processing module to retrieve at least one operation parameter in the corresponding look-up table according to the system operation state parameters to adjust the operation mode of the electronic device.

10. The electronic device of claim 9, wherein the plurality of system operation state parameters comprise a foreground program identification parameter, where the retrieving module retrieves the corresponding look-up table according to the foreground program identification parameter.

11. The electronic device of claim 10, wherein when there is no look-up table corresponding to the foreground program identification parameter, a default look-up table is retrieved from the plurality of look-up tables by the retrieving module.

12. The electronic device of claim 9, wherein the system operation state parameters comprise a system load, where the operation mode of the electronic device is adjusted according to the system load.

13. The electronic device of claim 12, wherein the operation parameter comprises an operation clock rate, where the operation mode of the electronic device is adjusted by adjusting an operating frequency of the electronic device to the retrieved operation clock rate.

14. The electronic device of claim 13, wherein the operating frequency is the operating frequency of a CPU of the electronic device.

15. The electronic device of claim 13, wherein the corresponding look-up table comprises a plurality of loading threshold values, the processing module further determines the relation of the system load and the loading threshold values to retrieve the operation parameter according to the relation.

16. The electronic device of claim 9, wherein the detecting module further detects the change of at least one background program executed by the electronic device to retrieve the plurality of system operation state parameters according to the changed foreground program and the background program.
